(19) United States
(12) Patent Application Publication
(10) Pub. No.: US 2012/0024194 A1
(43) Pub. Date: Feb. 2, 2012

(54) Method of Reducing Toxicity of Coal Combustion Residues

(75) Inventor: Rafic Minkara, Kennesaw, GA (US)

(73) Assignee: Headwaters Resources, Inc., South Jordan, UT (US)

(21) Appl. No.: 13/194,116

(22) Filed: Jul. 29, 2011

Related U.S. Application Data
(60) Provisional application No. 61/369,567, filed on Jul. 30, 2010.

(51) Int. Cl. C04B 14/00; B01D 53/64; B01D 53/46; B01D 53/76

(52) U.S. Cl. 106/400; 423/215.5

(57) ABSTRACT

Methods, processes, and systems for reducing the solubility of toxic constituents found in coal combustion residues are provided. In one embodiment, methods for adding chemical reagents to the coal combustion process that changes the chemical composition of the coal combustion residues and convert the form of a toxic constituents to one with lower aqueous solubility is provided. In some embodiments compounds containing toxic constituents are converted to compounds that are less soluble in aqueous solvents. In various embodiments, the chemical reactions are aided by the ambient heat at various zones within the coal combustion system. In some embodiments, precursor reagents are added to the coal combustion system and converted to reagents to aid in interacting with toxic constituents or compounds. In various embodiments, the reagent or reagent precursor is added before, during, or after the coal combustion zone. These methods can aid in rendering coal combustion products less hazardous when the products are recycled, stored, or disposed.

### CROSS REFERENCE TO RELATED APPLICATIONS

This application claims benefit of priority pursuant to 35 U.S.C. §119(e) of U.S. provisional patent application No. 61/369,567 filed 30 Jul. 2010, which is hereby incorporated herein by reference in its entirety.

### FIELD

The disclosed processes, methods, and systems are directed to the treatment of combustion gases and/or combustion residue in order to reduce the aqueous solubility of trace elements. Specifically the present processes, methods, and systems aid in reducing aqueous solubility of trace compounds found in fly ash from coal combustion.

### BACKGROUND

Coal is a combustible sedimentary rock used, for example, in generating electricity. Coal combustion products include flue gas, and residue such as coal ash and slag. Depending on the type of furnace used to combust the coal, the coal ash is further categorized as fly ash and bottom ash.

Fly ash is coal residue entrained with the combustion gasses in the exhaust, which normally escapes via a flue or chimney. Bottom ash is heavier and is usually recovered from the bottom of the boiler or furnace.

In many coal fired plants, fly ash is recovered before exiting the chimney through the use of filters, electrostatic precipitators, etc. Solid residue recovered from coal combustion can be stored, sent to disposal, or recycled in commercial applications. In some cases, coal combustion products are used in the manufacture of building materials, road construction materials, concrete, and cement, as well as soil augmentation.

The chemical makeup of coal combustion products, in general, varies depending upon the type and source of the coal used. Coal combustion products can contain trace amounts of toxic compounds, and in some cases, depending on the application, these trace compounds can be end up in the environment, for example in groundwater.

The United States Environmental Protection Agency (the USEPA) is proposing regulations to address the release of toxic trace elements from coal combustion products. In its 2007 report, the USEPA identified 67 towns in 26 states that had groundwater contaminated with heavy metals from coal combustion product disposal sites. The toxic compounds can include one or more of the following elements: arsenic, beryllium, boron, cadmium, chromium, cobalt, lead, manganese, mercury, molybdenum, selenium, strontium, thallium, and vanadium. Human and Ecological Risk Assessment of Coal Combustion Wastes, RTI, Research Triangle Park, Aug. 6, 2007, prepared for the U.S. Environmental Protection Agency.

### SUMMARY

Methods of reducing aqueous solubility of a toxic constituent present in a coal combustion residue are provided. As used herein, “constituent” is used interchangeably with “element,” and the “residue” is used interchangeably with “product.” In one embodiment the method comprises adding a reagent into a coal combustion system, reacting the constituent or a first compound containing the constituent with the reagent to ultimately form a second compound containing said constituent, wherein the second compound is less soluble in an aqueous solvent than the first compound.

Addition of reagents during the combustion process may reduce solubility/leachability when the combustion residue is contacted with water. In some embodiments, the introduction of reagents during combustion may allow the use of relatively inexpensive reagents, which are then converted to a more desirable reagent by the elevated temperatures found within the combustion system.

In various embodiments the constituent is converted to a less soluble form by reaction with the reagent. In various embodiments, the chemical reaction with a given reagent is aided by the ambient heat within the coal combustion system. In some embodiments, the added reagents are reagent precursors that are converted to reagents prior to reacting with the element. In various embodiments, the reagent or reagent precursor is added before, during, or after combustion of the coal has taken place. In various embodiments the second, less soluble, compound containing a toxic constituent is formed after the formation and collection of said coal combustion residue, when water is added thereby catalyzing reaction of the constituent, water, and a reagent, which may have been previously added into the combustion system. Methods disclosed herein can aid in rendering coal combustion residue less hazardous when the residue is recycled, stored, or disposed, by reducing the solubility and the potential leaching of toxic constituents.

In accordance with another embodiment, a delivery system comprising devices for injecting chemical reagents into a coal combustion system are provided. In various embodiments the system can be configured to inject reagents into the coal combustion zone, the flue gas handling system, or the ash handling system.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

### BRIEF DESCRIPTION OF THE DRAWINGS

FIG. 1 Depicts a coal combustion system and its various components, systems, devices, and zones.

FIG. 2 Depicts additional components of the coal combustion system of FIG. 1.

### DETAILED DESCRIPTION

Methods, processes, and systems for reducing the aqueous solubility of compounds found in coal combustion fly ash are provided. In one embodiment, disclosed herein are methods for adding chemical reagents to coal combustion products that result in lowered aqueous solubility for toxic compounds found in fly ash. In various embodiments, the chemical reagent is added before, during, or after combustion has taken place. In some embodiments, these methods render fly ash less hazardous when it is recycled, stored, or disposed.

More specifically, methods for lowering the aqueous solubility of elements found in coal combustion products are described. In some embodiments the element can be toxic or hazardous, or compounds or materials containing an element may be toxic or hazardous. In many embodiments, the methods described are directed to converting the form of a toxic element present in fly ash to a form with lower aqueous solubility. In other embodiments, a compound containing a toxic element is converted to a less aqueous-soluble compound or form.

As used herein, a toxic constituent or element may refer to an element in a specific form, compound, or material. In many embodiments, the form of a toxic constituent is altered to a less soluble form. In various other embodiments, a compound containing a toxic constituent is altered to form a compound containing the toxic constituent that is less soluble. Thus, the term toxic constituent may refer to an element, a specific form of an element, a compound containing the element, or a mineral containing a toxic element.

In various embodiments toxic constituents or elements can include any hazardous element or compound containing that element. For example, toxic constituents can include arsenic, beryllium, boron, cadmium, chromium, cobalt, lead, manganese, mercury, molybdenum, selenium, strontium, thallium, titanium, and vanadium. In other embodiments, the toxic constituent can be an alkaline earth compound, such as beryllium (Be), magnesium (Mg), calcium (Ca), strontium (Sr), barium (Ba) and radium (Ra). In various embodiments, toxic constituents can include transition elements, such as scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), lutetium (Lu), hafnium (Hf), tantalum (Ta), Tungsten (W), rhenium (Re), osmium (Os), iridium (Ir), platinum (Pt), gold (Au), mercury (Hg), actinium (Ac), rutherfordium (Rf), dubnium (Db), seaborgium (Sg), bohrium (Bh), hassium (Hs), meitnerium (Mt), darmstadtium (Ds), roentgenium (Rg), and copernicium (Cn).

In general, coal combustion and coal combustion residues or products are formed during the process of burning coal and the chemicals, gases, and particulate matter produced there from. In various embodiments, coal combustion requires collecting coal combustion residues, and storing, disposing, or transferring the coal combustion residues. In addition to long term storage, or disposal, coal combustion residue can be recycled or reused in various ways. Coal combustion products can be recycled as construction materials, such as Portland cement concrete additive, shingles, wallboard, cement, or masonry.

In many embodiments, decreasing the aqueous solubility of toxic constituents and compounds found in coal combustion products can help prevent release of toxic constituents and compounds containing those elements into the environment. For example, when one coal combustion product, fly ash, is stored, disposed of, or recycled, soluble toxic constituents can leach from the fly ash, or product containing fly ash, into the environment. In many cases, the present methods reduce the cost and improve the environmental performance of coal fired electric generation.

In various embodiments, aqueous solubility can refer to the tendency of an element or compound to be dissolved in water. In various embodiments, the water may be deionized, distilled, acidic, basic, high ionic strength, low ionic strength, or combinations thereof. In some cases, aqueous solubility can be expressed as the amount of a given element or compound that can be dissolved in a given amount of solvent. Aqueous solubility may be expressed in terms of moles, or molarity, normality, weight, or other terms of concentration. In many cases, aqueous solubility of a given compound can vary with temperature, pressure, pH, and ionic strength of a given solvent. The aqueous solubility of some common compounds can be measured by one of skill in the art. In addition, aqueous solubility data for some common compounds is known, and an exemplary chart including this type of data can be found at http://en.wikipedia.org/wiki/Solubility_table.

In general a compound or element that is more soluble can be more leachable. For example, leachability can refer to the ability of a given compound to be liberated from a solid, for example fly ash, by a percolating liquid. In some embodiments leachability of a given element or compound can increase with the aqueous solubility of the elements or compounds. Leachability may be determined experimentally. For example, leachability may be determined using USEPA testing procedures such as Toxicity Characteristic Leaching Procedure (TCLP), Synthetic Precipitation Leaching Procedure (SPLP), etc. Leaching data for various elements is available in the “Characterization of Coal Combustion Residues from Electric Utilities—Leaching and Characterization Data,” EPA-600/R-09/151, December 2009 (available at http://www.epa.gov/nrmrl/pubs/600r09151/600r09151.html; incorporated by reference herein in its entirety).

Some of the constituents or elements and compounds collected with coal combustion products, for example bottom ash, fly ash, and flue gas desulferization (FGD) materials, can be water soluble. Where these soluble elements or compounds are toxic, they can end up contaminating the environment, for example groundwater. The ability to leach from the combustion product (i.e. leachability) can depend on many factors, for example, the chemistry of the solid matter, the chemistry of the leaching water, the amount of water, the amount of solid matter, the porosity of the solid matter, etc. To reduce the leachability of toxic constituents from coal combustion products, the chemical composition of the coal combustion product can be modified to aid in reducing the aqueous solubility of toxic constituents and compounds.

Leaching of toxic constituents and compounds by water from the solid matter in coal combustion products depends on many factors including the chemistry of the solid matter, the chemistry of the leaching water, and the liquid/solid (L/S) ratio. In various embodiments, an element can be more leachable in high pH liquids than low pH liquids, while other elements can have the opposite leachability profile, for example, chromium (Cr) has a relatively higher leachability in an acid-leaching solution, while lead (Pb) has a higher leachability in an alkaline solution.

In various embodiments, coal can refer generally to combustible sedimentary rock in various forms. The term coal can also include various grades and types of coal including, anthracite, bituminous, sub-bituminous, and lignite. In many embodiments, coal can contain trace amounts of toxic elements including arsenic, beryllium, boron, cadmium, chromium, cobalt, lead, manganese, mercury, molybdenum, selenium, strontium, thallium, and vanadium. The identity and relative amounts of these elements can depend upon the type and source of the coal.

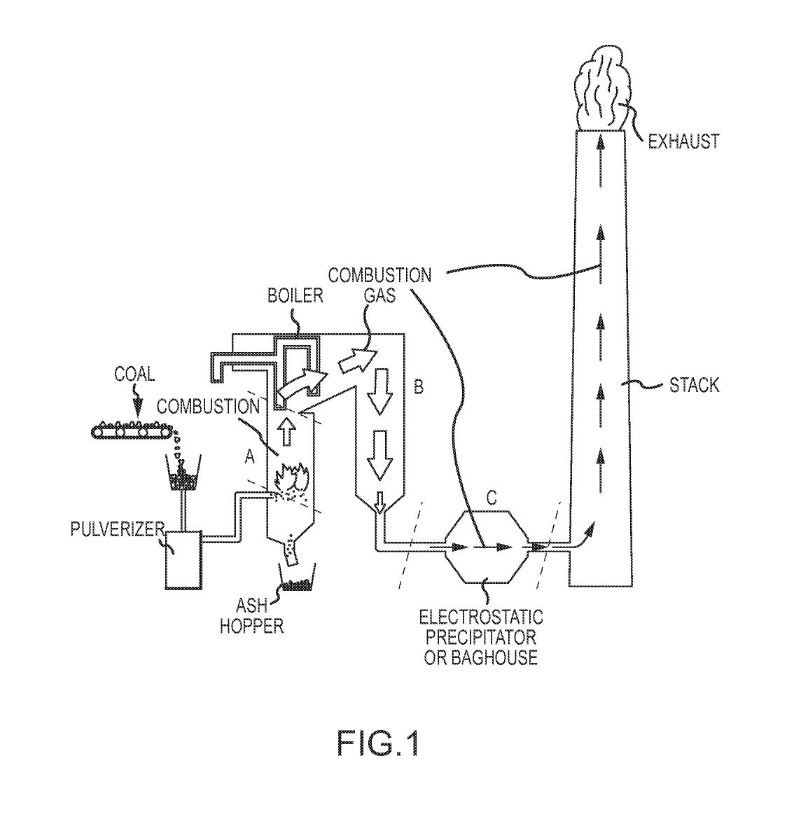

In various embodiments, coal can be combusted in a coal combustion system. A coal combustion system can include a furnace for generating steam and electricity. In some embodiments, trace elements can vaporize in the high temperature combustion zone and then can begin to condense into particulate forms as the element travels through the coal combustion system. As depicted in FIG. 1, a coal combustion system may comprise a combustion zone (marked “A” in FIG. 1), a heat extraction zone (marked “B”), and a particulate collection zone (marked “C”). The combustion zone may comprise combustion systems, components, and devices, and may have temperatures of between about 1300 and 1500° C. The heat extraction zone may comprise heat extraction systems, components, and devices, and may have temperatures of between about 1500 and 150° C. The particulate collection zone may comprise particulate collection systems, components, and devices, and may generally have temperatures at or below about 150° C. The heat extraction zone components may comprise a superheater, an economizer, and an air heater. In various coal combustion systems, there may be a particulate collection zone within the heat extraction zone. In general, the heat extraction zone ends at an exit of the air heater, about 150° C.

In various embodiments toxic constituents in or associated with the coal can be deposited on coal combustion product particles (such as fly ash) or can be co-mingled with alumino-silicate glass of fly ash. In most embodiments, these particles will be captured and collected in the particulate collection systems of most coal combustion systems. Particulate collection systems can include electrostatic precipitators, filter fabric, bag houses, etc.

In various other embodiments, toxic constituents or compounds containing toxic elements can escape capture in the particulate collection devices, and can be captured in flue gas desulfurization (FGD) devices, such as lime or limestone based wet scrubbers. Elements that are not captured in particulate collection and wet scrubbers can be emitted to the atmosphere.

The present method is directed to a process that can aid in converting toxic constituents and/or compounds containing those toxic constituents, found in coal combustion products into less soluble forms. The process can aid in rendering the coal combustion products less hazardous by decreasing the aqueous solubility of toxic constituents or compounds found in the combustion products and in turn can decrease their leachability from the coal combustion product or recycled material containing the coal combustion product.

In various embodiments, chemical reagents can be added to the coal combustion system. In various embodiments, the reagents can be injected into the coal combustion system. In some embodiments the reagents can be added to the coal before combustion. In other embodiments the reagent can be added downstream of the combustion chamber and react with toxic constituents within the combustion products. In various embodiments, the reagent can react with arsenic, selenium, boron, or mercury, or compounds containing those elements, can undergo chemical reactions within the coal combustion system to produce a compound with lower solubility.

In various embodiments, the reagent can be a chemical oxidant or oxidizing compound. Oxidizing compounds can include chemical compounds and substances that readily transfer oxygen atoms, or a chemical compound or substance that gains electrons in a chemical reaction that change an atom's degree of oxidation or charge. In some embodiments, the reagent can be a chemical oxidant, such as calcium hypochlorite (Ca(OCl)₂). In various embodiments the chemical oxidant can be added into a high temperature zone of the combustion system.

In general chemical reagents can be added to any step of coal combustion system. In various other embodiments the chemical reagents are added at multiple steps within the coal combustion system. In various other embodiments, the reagent, and/or a precursor of the reagent, can be added to the combustion system.

In various embodiments chemical reagents can be added prior to combustion. For example, reagents can be mixed with coal prior to adding the coal to the combustion chamber.

In other embodiments, chemical reagents can be added into the combustion zone. In other embodiments, chemical reagents can be added into the flue gas handling system. The chemical reagents can also be added into the coal combustion products collection, transfer, and handling systems such as electrostatic precipitators, filter fabric dust collectors, hoppers, pneumatic transfer lines, storage silos, and load-out systems.

For example, the reactions below demonstrate one way in which the toxicity of arsenic in fly ash may be reduced by reducing its solubility through the present method. Included in the table are representative reagents, reactions, and reaction conditions for use with the method.

| | Target | Less soluble | Reagent | Reaction: |
|---|---|---|---|---|
| 1. | As(III) As₂O₃ | As(IV) As₂O₅ | Ca(OCl)₂ | Ca(OCl)₂ + As₂O₃ => CaCl₂ + As₂O₅ |
| 2. | | | Ca(OH)₂ | As₂O₃ + 2Ca(OH)₂ => 2CaHAsO₃ + H₂O |
| 3. | | | Ca₃(AsO₄)₂ | As₂O₅ + 3Ca(OH)₂ => Ca₃(AsO₄)₂ + 3H₂O |

### Arsenic

In one embodiment, arsenic containing compounds can be oxidized to form less soluble compounds. Arsenic is classified as a Class A carcinogen by the Environmental Protection Agency, and is commonly found in coal. Arsenic recovered from coal combustion flue gas generally occurs as As₂O₃, which is more soluble than arsenic in the form of As₂O₅. In various embodiments, the aqueous solubility of arsenite As(III), As₂O₃, can be reduced by reacting it with calcium hypochlorite to form the less soluble arsenate As(V) form, As₂O₅.

In various embodiments Ca(OCl)₂ can be injected into high temperature flue gas to aid in conversion of As₂O₃ to As₂O₅. The resulting reactive calcium oxide would favor the formation of calcium arsenate. Oxidation of arsenite to arsenate is shown in reaction 1, below.

Ca(OCl)₂+As₂O₃=>CaCl₂+As₂O₅ 1.

In some embodiments, other species compete for the reactive calcium, and additional calcium can be added in the form of lime. In other embodiments, the addition of lime to the combustion system converts As₂O₃ and As₂O₅ to CaHAsO₃ and Ca₃(AsO₄)₂, further decreasing the aqueous solubility of arsenic compounds in fly ash. In other embodiments, for example where the flue gas environment is acidic, hydrous ferric oxide Fe(OH)₃ can be added to the combustion system to reduce the aqueous solubility of arsenic compounds therein by forming ferric arsenate, FeAsO₄.2H₂O. For example through the reaction, 2Fe(OH)₃+As₂O₅+H₂O=>2FeAsO₄.2H₂O. In other embodiments, the arsenate may be immobilized by adsorption on various ferric hydroxides, which may be formed through oxidation of injected elemental iron powder Fe(0) with oxygen contained in flue gas.

In other embodiments, lime Ca(OH)₂ can be used in conjunction w/CalHypo (Ca(OCl)₂) to further reduce the aqueous solubility of Arsenic. The oxidation reaction can occur before ash collection and after economizer or typically in the range of 250° C. to 450° C. Commercial CalHypo contains some lime. However, the injected reagent can be supplemented with additional lime to get the desired reduction. The reactions of arsenite and arsenate w/calcium hydroxide are shown in reactions 2 and 3, below. In various embodiments, these two reactions can occur at ambient temperature or higher, but below 580° C. The lowered temperature can aid in preventing decomposition of calcium hydroxide.

As₂O₃+2Ca(OH)₂=>2 CaHAsO₃+H₂O 2.

As₂O₅+3Ca(OH)₂=>Ca₃(AsO₄)₂+3H₂O 3.

Many of the toxic compounds found in fly ash can be converted to a less soluble form to help reduce the toxicity of the fly ash in general and fly ash leachate in particular.

### Selenium

Selenium species in flue gas would not benefit from gas phase oxidation. In general, selenium compounds found in coal combustion products tend to have a higher oxidation state. For example, compounds containing selenate, SeO₄²⁻, are more soluble in water than selenite or elemental selenium. (CuSeO₄ has a aqueous solubility of 17.5 g/100 ml H2O at 20° C.), than compounds containing selenite, SeO₃²⁻ (CuSeO₃ has a aqueous solubility of 0.002761 g/100 ml H2O at 20° C.).

In various embodiments, where toxic compounds of selenium contained in coal may become more soluble by oxidation through the combustion process to selenate and sometimes selenite forms, these oxidized forms would be reduced to less soluble selenite and much less soluble elemental selenium by chemical reduction using finely divided elemental iron powder injected in the flue gas prior to particulate collection or during transfer of collected particulates. In various embodiments, the source of elemental or zero valent iron can be cast iron borings, a waste product from the machining of iron castings. Upon contact with water, the more soluble selenate compound may be reduced to form selenites and elemental Se which would be form an insoluble complex with the formed iron oxide such as Fe(OH)₃.Se°, for example: SeO₄²⁻+Fe°+2H₂O→Fe(OH)₃+SeO₃²⁻+H⁺, or SeO₃²+Fe°+3H⁺→Fe(OH)₃.Se°

In various embodiments, where the toxic constituent contained in coal combustion products would be more soluble in its highest oxidation state, the toxic element or compound can be made less soluble by adsorption to ettringite (3CaO.Al₂O₃.3CaSO₄.32H₂O) and monosulfate (3CaO.Al2O₃.CaSO₄.12H₂O). In various embodiments, ettringite and monosulfate reagents can be produced or created within the flue gas from the addition of alumina and calcium containing reagents. In many embodiments, Alumina and calcium containing reagents could be added at various stages in the production of coal combustion products. In some embodiments, alumina and calcium containing reagents can be added with the fuel into the boiler. In other embodiments, the alumina and calcium containing reagents can be added to the flue gas after coal combustion. In embodiments where the calcium containing reagent can be added to the fuel, the reagent can be in the form of calcium carbonate. In embodiments where the calcium reagent can be added post-combustion, for example injected into the flue gas, the calcium reagent can be calcium oxide. In further embodiments where the alumina reagent can be added post combustion into the flue gas the reagent could be sodium aluminate. In further embodiments, calcium sulfate can be added as needed to meet the stoichiometric requirements for the formation of ettringite and monosulfate and adsorption of toxic compounds thereto.

In various other embodiments, the toxic constituent species are in metal oxy-anion forms (MO₄⁻²), such as: Selenate SeO₄⁻², Selenite SeO₃⁻², Chromate CrO₄⁻², Vanadate VO₄⁻², Molybdate MoO₄⁻², etc. Conversion of metal oxy-anion forms to less soluble forms can involve the addition of lime (CaO), alumina (Al₂O₃), and gypsum (CaSO₄). In some embodiments, CaO, Al₂O₃ and CaSO₄ and associated products can be collected with the fly ash in the electrostatic precipitator or baghouse. These reagents can react with toxic constituents or compounds to form ettringite and monosulfate. This reaction can occur at ambient temperature when fly ash is exposed to water or moisture.

For example, toxic metal oxy-anions, for example, SeO₄⁻², SeO₃⁻², CrO₄⁻², VO₄⁻², MoO₄⁻², can substitute for the sulfate SO₄⁻² in the ettringite and monosulfate to make the less soluble forms metal oxy-anions. In general terms, MO₄⁻² substituted ettringite and monosulfate are shown in reactions 4 and 5 respectively. In reactions 4 and 5, the MO₄⁻² can be any of the SeO₄⁻², SeO₃⁻², CrO₄⁻², VO₄⁻², MoO₄⁻², etc.

3CaO+Al₂O₃+3CaMO₄+32H₂O=>3CaO.Al₂O₃.3CaMO₄.32H₂O 4.

3CaO+Al₂O₃+CaMO₄+12H₂O=>3CaO.Al₂O₃.CaMO₄.12H₂O 5.

In various embodiments reagent precursors can be added to the combustion system and converted into the reagent by the high combustion system temperatures. In some embodiments precursor reagents may be less expensive than the reagent. For example, in various embodiments the reagent CaO is converted from precursor reagents such as limestone, lime kiln dust, or other inexpensive calcium carbonate (CaCO₃) containing compounds. In various embodiments the calcium carbonate can be injected into the flue gas. In other embodiments the calcium carbonate reagent can be injected upstream of the 840° C. temperature zone to aid in converting the calcium carbonate to CaO.

In one embodiment, alumina (Al₂O₃) can be added to the coal combustion system as aluminum hydroxide (AlOH₃) or hydrated alumina. In some embodiments the aluminum hydroxide can be inject into the flue gas upstream of the 200° C. temperature zone where the aluminum hydroxide can decompose into alumina and water vapor.

In embodiments where gypsum is used, the gypsum can be injected in the flue gas downstream of the 1000° C. temperature zone in order to help prevent decomposition SO₂. While gypsum may not be needed for the substitution reactions, due to the possible presence of MO₄⁻² in replacement of SO₄⁻², gypsum may be used for the adsorption/immobilization in the ettringite and monosulfate reactions.

### EXAMPLES SECTION

### Leachability Testing

The following non-limiting examples are provided to describe certain embodiments of the disclosure. It will be apparent to those skilled in the art that many modifications, both to materials and methods, may be practiced without departing from the scope of the disclosure.

### Example 1

### Reagents Combined with Collected Fly Ash

The leachability of various elements from fly ash was analyzed. Specifically, the leachability, from dry fly ash samples, of Arsenic, barium, cadmium, chromium, lead, mercury, Selenium, and silver was tested. Three different reagents were tested for their ability to affect leachability, elemental iron powder, alumina+CaO, or Calhypo+CaO, at varying amounts (Fe: 0.25%, 0.50%, 1%, 2%, and 4%; Alumina+CaO: 1.875%+0.635%, and 3.75%+1.25%; and CalHypo+CaO: 0.1%+0.3% and 0.2%+0.6%). Leachability of the various elements from treated fly ash was compared to leachability from untreated fly ash.

Samples of fly ash were collected from eastern bituminous-coal fired boiler. Reagents, in predetermined amounts, were combined and mixed into to the fly ash sample. In the case of the control sample, no reagent was added. Next, fly ash samples were conditioned by the addition of about 20% water (40 mL of water per 200 gram mixture) and stirring the mixture by hand in an appropriate sized beaker. This water addition simulates typical conditioning performed on fly ash prior to disposal.

Leachability testing was performed according to EPA TCLP (Total Characteristic Leachate Procedure—test method 1311). Briefly, 100 grams of treated or untreated fly ash sample was mixed with 2000 mL Extraction fluid #1 (5.7 mL of glacial acetic acid to 500 mL reagent water, add 64.3 mL of 1 N NaOH and dilute to 1000 mL). In cases where the pH is above 5.0, and remains above 5.0 after treatment with 3.5 mL of 1N HCl at 50° C., Extraction fluid #2 is used (5.7 mL glacial acetic acid diluted in 100 mL reagent water). The ash sample in extraction fluid is agitated for 18±2 hours, filtered through 0.6-0.8 μm borosilicate glass filter. Filtered extraction buffer is then analyzed for various elements.

Concentrations of the various elements (Arsenic, Barium, Cadmium, Chromium, Lead, Mercury, Selenium, and Silver) found in the leachate of a 100 gram fly ash sample is shown in Table 1. Line A is the concentration of elements (expressed in mg/L) from leachate of a control, untreated sample of fly ash. Lines B1-B4 are concentrations of elements (expressed in mg/L) in leachate from fly ash treated with 0.25%, 0.50%, 1%, 2%, and 4% elemental iron powder, respectively. Lines C1-C2 show element concentrations (expressed in mg/L) in samples treated with 1.875%+0.635%, and 3.75%+1.25% alumina+CaO, respectively. Lines D1-D2 show element concentrations (expressed in mg/L) in leachate of fly ash samples treated with 0.1%+0.3% and 0.2%+0.6% CalHypo+CaO, respectively.

Table 1 shows that addition of reagents to collected fly ash greatly reduces the leachability of several elements. For example, the use of elemental iron at proportions ranging from 0.25% (line B1) to 4.0% (line B4) relative to the amount of ash, results in over 90% reduction in Arsenic leachability and between 50% and 92% reduction in Selenium. Addition of 0.1%+0.3% CalHypo+lime (line D1) to the fly ash reduced leachable Arsenic nearly 90% and leachable Selenium was reduced 25%. Doubling of the amount of CalHypo+lime added to the fly ash, from 0.1%+0.3% (line D1) to 0.2%+0.6% (line D2) resulted in reduction of both Arsenic and Selenium 91%. Finally, Table 1 demonstrates that the use of Alumina+lime at either 1.875%+0.635% (line C1) or 3.75%+1.25% (line C2) reduced leachable Selenium 71% and 84%, respectively. Addition of Alumina+lime reduced leachable Arsenic 98%.

Also shown in Table 1 are the regulatory limits for the tested elements. These limits are in most cases higher than that found in flyash. For example the control leachate contained only 5.0 mg/L of Arsenic, which is approximately 10% of the Regulatory Limit, while 1.0 mg/L of Selenium was found in the fly ash leachate, which is 100% of the Regulatory Limit. Thus, addition of the reagents tested reduce the amount of Arsenic and Selenium found in fly ash leachate well below the Regulatory Limits.

These experiments demonstrate that addition of elemental iron, alumina+CaO, or CalHypo+CaO is an effective method to reduce the leachability of both Arsenic and Selenium.

TABLE 1

Reagent
Dosages

Element

| | | | | | | | |
|---|---|---|---|---|---|---|---|
| As | Ba | Cd | Cr | Pb | Hg | Se | Ag |

TCLP Regulatory Limit

| | | | | | | | |
|---|---|---|---|---|---|---|---|
| 5.0 | 100 | 1.0 | 5.0 | 5.0 | 0.2 | 1.0 | 5.0 |

CONTROL - NO Treatment

| | | | | | | | | |
|---|---|---|---|---|---|---|---|---|
| A | 0.5 | 0.2 | 0.006 | 0.031 | 0.014 | <0.0001 | 1.0 | <0.001 |

Treated with Elemental Fe Powder

| | | | | | | | | | | |
|---|---|---|---|---|---|---|---|---|---|---|
| | | | | | | | | | | Fe |
| mg/L in | B1 | 0.051 | 0.194 | 0.002 | 0.044 | <0.0066 | 0.000351 | 0.508 | <0.0012 | 0.25% |
| Leachate | B2 | 0.052 | 0.236 | 0.002 | 0.047 | <0.0066 | 0.000179 | 0.431 | <0.0012 | 0.50% |
| | B3 | 0.008 | 0.518 | 0.001 | 0.055 | <0.0066 | 0.000453 | 0.0864 | <0.0012 | 1.00% |
| | B4 | 0.017 | 0.235 | 0.002 | 0.046 | <0.0066 | 0.000303 | 0.105 | <0.0012 | 2.00% |
| | B5 | 0.054 | 0.285 | 0.003 | 0.051 | 0.0096 | 0.000313 | 0.108 | <0.0012 | 4.00% |

Treated with Alumina + CaO

| | | | | | | | | | | |
|---|---|---|---|---|---|---|---|---|---|---|
| | | | | | | | | | Alumina | CaO |
| C1 | 0.011 | 0.263 | 0.002 | 0.07 | <0.0066 | 0.000241 | 0.303 | <0.0012 | 1.875% | 0.635% |
| C2 | 0.014 | 0.314 | 0.002 | 0.067 | <0.0066 | 0.000294 | 0.163 | <0.0012 | 3.75% | 1.25% |

Treated with Calhypo + CaO

| | | | | | | | | | | |
|---|---|---|---|---|---|---|---|---|---|---|
| | | | | | | | | | CalHypo | CaO |
| D1 | 0.061 | 0.233 | 0.002 | 0.072 | <0.0066 | 0.00061 | 0.781 | <0.0012 | 0.10% | 0.30% |
| D2 | 0.050 | 0.241 | 0.002 | 0.092 | <0.0066 | 0.000929 | 0.0893 | <0.0012 | 0.20% | 0.60% |

### Example 2

### Reagent Injection into Furnace

Fly-ash samples are collected while firing coal in a test furnace during injection of reagents. The fly-ash samples are analyzed for leachability of Selenium and Arsenic.

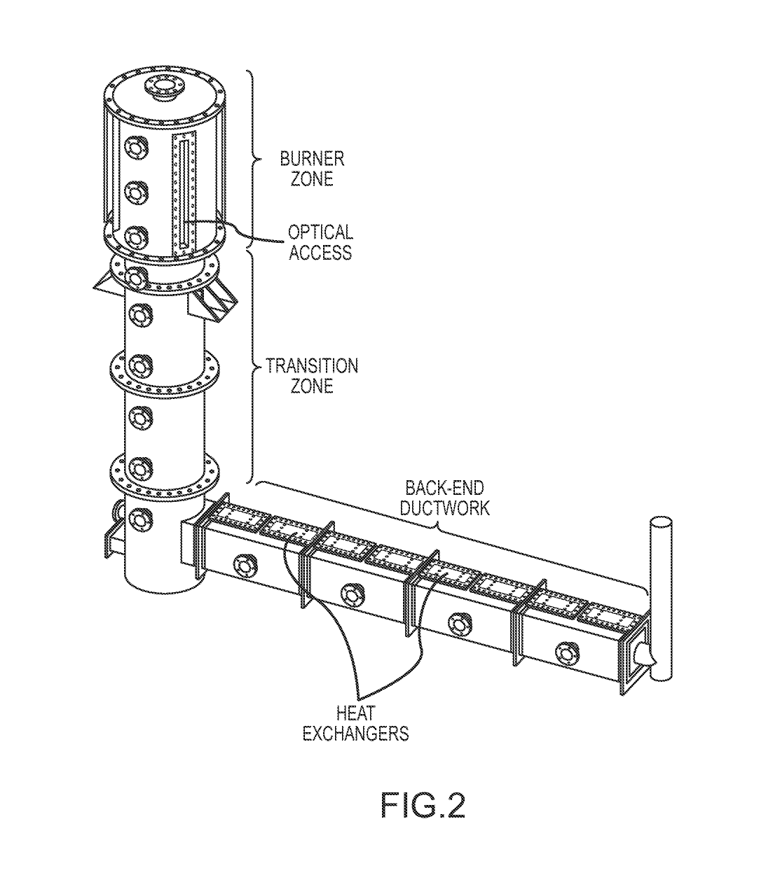

The furnace, shown in FIG. 2, is a down-fired combustor, which fires coal at a rate of 125 kW. The furnace is used in its normal air combustion mode, but may also be used in an Oxy mode for various tests. The furnace is used to study flame stability and ash characterization during oxy-coal combustion, or with air as the oxidizer. The furnace has electrically heated walls in the near-burner region and contains three main sections: Burner Zone, Transition Zone, and Back-end and Ductwork. The Burner Zone for these experiments is 0.6 m in diameter and 1.2 m in length. The Transition Zone is 3.7 m in length, and contains cooling coils. The horizontal Back-end Ductwork is 7 m in length. The Burner Zone is equipped with quartz windows for visual observation and optical diagnostics (marked Optical Access in FIG. 2). The Back-end Ductwork is equipped with eight heat exchangers that can be turned on or off in each section to provide the desired temperature profile. The furnace is equipped with continuous emissions monitoring (CEM) for O₂, CO₂, CO, NOₓ, and SO₂. Following the back-end ductwork, particulates are removed from the flue gas in a fabric filter.

A baseline sample is collected while firing a coal of interest for the control sample. Experimental samples are collected while injecting reagent at the Back-end Ductwork. Samples of greater than 200 grams are retrieved, and filter bags as well as the hopper are cleaned between samples.

For a given coal, the reagent injection strategy for the present experiments are shown in Table 2 (wherein, reagent rates are in % wt of coal ash):

TABLE 2

| | | | | Alumina/ |
|---|---|---|---|---|
| | Elemental | Calhypo/ | Alumina/ | Lime |
| Reagent | Iron | Lime | Lime | (Mixed with |
| Rate | (Slurry) | (Slurry) | (Slurry) | coal) |
| Low | 0.50% | 0.1%/ | 0.94%/ | 0.94%/ |
| | | 0.3% | 0.31% | 0.31% |
| Middle | 1.00% | 0.2%/ | 1.88%/ | 1.88%/ |
| | | 0.6% | 0.64% | 0.64% |
| High | 2.00% | 0.4%/ | 3.75%/ | 3.75%/ |
| | | 1.2% | 1.25% | 1.25% |

The solid reagents are injected as a slurry, prepared with an appropriate surfactant to ensure a homogenous mixture and an even flow rate into the Back-end Ductwork. Slurry is injected into the Back-end Ductwork using a variable flow diaphragm pump and an injection lance. The temperature at the injection location is between 250° C. and 450° C. In some injections, the temperature at the injection location is between 250° C. and 300° C.

Leachability is tested as described in Example 1.

All references disclosed herein, whether patent or non-patent, are hereby incorporated by reference as if each was included at its citation, in its entirety.

Although the present disclosure has been described with a certain degree of particularity, it is understood the disclosure has been made by way of example, and changes in detail or structure may be made without departing from the spirit of the disclosure as defined in the appended claims.

We claim:

1. A method of reducing aqueous solubility of a toxic constituent present in a coal combustion residue comprising:
reacting the toxic constituent or a first compound containing the toxic constituent with a chemical reagent in the coal combustion residue to form a second compound containing said toxic constituent, wherein the second compound is less soluble in an aqueous solvent than the first compound.

2. A method of reducing the leachability of elements found in coal combustion products comprising:
introducing a chemical reagent that alters the solubility of coal combustion products in a flue gas into a coal combustion system.

3. The method as recited in claim 1, wherein the chemical reagent is injected into a combustion zone of the combustion system.

4. The method as recited in claim 1, wherein the chemical reagent is injected after a combustion zone of the combustion system.

5. The method as recited in claim 1, wherein the chemical reagent is injected into a flue gas system after a heat extraction zone of the combustion system.

6. The method as recited in claim 1, wherein the chemical reagent is injected into a flue gas handling system before a particulate collection system.

7. The method as recited in claim 1, wherein the chemical reagent is selected from one or more oxidizing compounds.

8. The method as recited in claim 1, wherein the chemical reagent is selected from one or more reducing compounds.

9. The method as recited in claim 1 wherein the chemical reagent is selected from one or more alkaline earth compounds.

10. The method as recited in claim 1, wherein the chemical reagent is selected from one or more transition metal compounds.

11. The method as recited in claim 1, wherein the chemical reagent is selected from one or more sorbents such activated silica gel, activated alumina, and activated carbon.

12. The method as recited in claim 1, wherein the toxic constituent is arsenic.

13. The method as recited in claim 12, wherein a reaction between the toxic constituent and the chemical reagent is Ca(OCl)₂+As₂O₃=>CaCl₂+As₂O₅.

14. The method as recited in claim 1, wherein the toxic constituent is selenium.

15. The method as recited in claim 14, wherein a reaction between the toxic constituent and the chemical reagent is SeO₄²⁻+Fe+2H₂O→Fe(OH)3+SeO₃²⁻+H.

16. The method as recited in claim 14, wherein a reaction between the toxic constituent and the chemical reagent is SeO₃²+Fe+3H⁺→Fe(OH)3.Se.

17. A method of reducing the leachability of elements found in coal combustion products comprising:
adding a reagent to the combustion product;
mixing the reagent and combustion product to form a composition;
adding an amount of water to the composition; and
mixing the water and composition.

18. The method as recited in claim 17, wherein the reagent is selected from the group consisting of elemental iron, alumina+CaO, or CalHypo+CaO.

19. The method as recited in claim 17, wherein the element is arsenic or selenium.

20. The method as recited in claim 17, wherein the amount of water is 20%.
